(19) United States
(12) Patent Application Publication
(10) Pub. No.: US 2013/0002683 A1
(43) Pub. Date: Jan. 3, 2013

(54) METHOD, APPARATUS AND CLIENT DEVICE FOR DISPLAYING EXPRESSION INFORMATION

(75) Inventors: Xiaoman LI, Shenzhen City (CN); Bin CHEN, Shenzhen City (CN); Weiwen XIE, Shenzhen City (CN); Anqi LI, Shenzhen City (CN)

(73) Assignee: TENCENT TECHNOLOGY (SHENZHEN) COMPANY LIMITED, Shenzhen City (CN)

(21) Appl. No.: 13/613,596

(22) Filed: Sep. 13, 2012

Related U.S. Application Data
(63) Continuation of application No. PCT/CN2011/076033, filed on Jun. 21, 2011.

(30) Foreign Application Priority Data
Jun. 21, 2010 (CN) 201010204165.2

(51) Int. Cl. G06T 13/00

(52) U.S. Cl. 345/473

(57) ABSTRACT

A method for displaying expression information is disclosed, which is applied to an instant messaging system and which includes following steps: a client receives or sends expression information through a chat window; the client transforms attributes of the chat window and an expression image corresponding to the expression information according to animation parameters corresponding to the expression information, and displays the animation effect obtained through the attribute transformation. An apparatus applying the above method and a client device are also provided. By using the solution, the interactivity with the expression information display can be improved.

The present application is a continuation application of PCT/CN2011/076033, filed on Jun. 21, 2011, which claims the priority of Chinese Patent Application No. 201010204165.2, filed on Jun. 21, 2010 with the Chinese Patent Office and titled “Method and apparatus for displaying expression information”, the contents of which are incorporated by reference in their entirety.

### TECHNICAL FIELD

The present invention relates to computer technology, and more particular to a method, apparatus and client device for displaying expression information.

### BACKGROUND OF THE INVENTION

With the development of the network technology and the extension of the network influence, instant messaging (IM) tools have been accepted by the majority of internet users, and become essential software tools for users, and have been widely used in the usual leisure entertainment and users' work. Thus, the users put forward high requirements for usability, stability, security, and other aspects of the instant messaging software.

In the process of using IM tools, one user usually uses a plurality of interesting expression effects to convey information. The existing expression effects are generally achieved through jpg static images, gif dynamic images and dynamic composite graphs and so on; the expression content is generally one or more images, or image plus words, and is displayed in a fixed area (message content part) in the chat window through the static transmission mode.

### SUMMARY OF THE INVENTION

The present invention provides a method, apparatus and client device for displaying expression information, which can realize animation effect corresponding to expression information.

One embodiment of the present invention provides a method for displaying expression information, which includes following steps:

receiving or sending through a chat window, by a client, an expression information;

performing, by the client, an attribute transformation on the chat window and an expression image corresponding to the expression information according to animation parameters corresponding to the expression information, and displaying, by the client, an animation effect obtained through the attribute transformation.

One embodiment of the present invention also provides an apparatus for displaying expression information, which is applied to an instant messaging system and includes:

a communication module configured to receive or send expression information through a chat window;

an attribute transformation module configured to perform an attribute transformation on the chat window and an expression image corresponding to the expression information according to animation parameters corresponding to the expression information received or sent by the communication module;

a display module configured to display animation effect obtained by the attribute transformation module.

One embodiment of the present invention also provides a client device comprises a computer storage media for storing computer-executable instructions client device including, the computer-executable instructions are for displaying expression information which is applied to an instant messaging system, the method comprises:

receiving or sending through a chat window, by a client, an expression information;

performing, by the client, an attribute transformation on the chat window and an expression image corresponding to the expression information according to animation parameters corresponding to the expression information, and displaying, by the client, an animation effect obtained through the attribute transformation

Comparing with the existing technology, the present invention has following advantages: the present invention can obtain and display the animation effect after the attributes have been transformed through performing attribute transformations on the chat window and the expression image, and the expression information can be vividly displayed through the chat window, this enriches the expression effects and facilitates the user to understand the expression information and increases the interactivity of the IM client and improves the usability of the IM client.

### BRIEF DESCRIPTION OF THE DRAWINGS

In order to more clearly illustrate technical solutions of the present invention or the existing technology, the figures which are needed to be used in the description of the present invention or the existing technology will be briefly described in the following. Obviously, the figures in the following description are only some embodiments of the present invention, and it is easily for those skilled in the art to obtain other figures based on the following figures without creative work.

FIG. 1 is a flow chart of a method for displaying expression information of the present invention;

FIG. 2 is a flow chart of displaying expression information in an application scene of sending a “hit” expression according to the present invention;

FIG. 3 is a schematic diagram of sending the “hit” expression according to the present invention;

FIG. 4 is a schematic diagram of an animation effect in the application scene of sending the “hit” expression according to the present invention;

FIG. 5 is a flow chart of displaying expression information in an application scene of receiving a “hit” expression according to the present invention;

FIG. 6 is a schematic diagram of an animation effect in the application scene of receiving the “hit” expression according to the present invention;

FIG. 7 is a flow chart of displaying expression information in an application scene of receiving an “angry” expression according to the present invention;

FIG. 8 is a schematic diagram of an animation effect in the application scene of receiving the “angry” expression according to the present invention;

FIG. 9 is a schematic diagram of an apparatus for displaying expression information of the present invention.

### EMBODIMENTS OF THE INVENTION

To make the objectives, technical solutions and advantages of the present invention more clear, the present invention is hereinafter described in detail with reference to the accompanying drawings and embodiments.

In the process of achieving the present invention, the inventor found that the display of expression information in the existing technology lacks interactivity. Further, the form of expression information in the existing technology is single, and it is difficult to fully express the user's intention.

In view of this, in the technical solution provided in one embodiment of the present invention, according to an expression information received or sent by a chat window of an IM client, an attribute transformation is performed on the chat window and an expression image corresponding to the expression information, and an animation effect obtained through the attribute transformation is displayed. Through the abundant expression effects of the chat window, the expression information can be vividly displayed through the chat window, to facilitate the user to understand the expression information and improve the interactivity during the process of sending and receiving messages by the user.

The technical solution of the present invention will be clearly and completely described hereinafter with reference to the accompanying drawings of the present invention, obviously, the described embodiments are only parts of the embodiments of the present invention and not all the embodiments. Based on the embodiments of the present invention, all the other embodiments that can be obtained by one skilled in the art without any innovative work fall in the protection scope of the present invention.

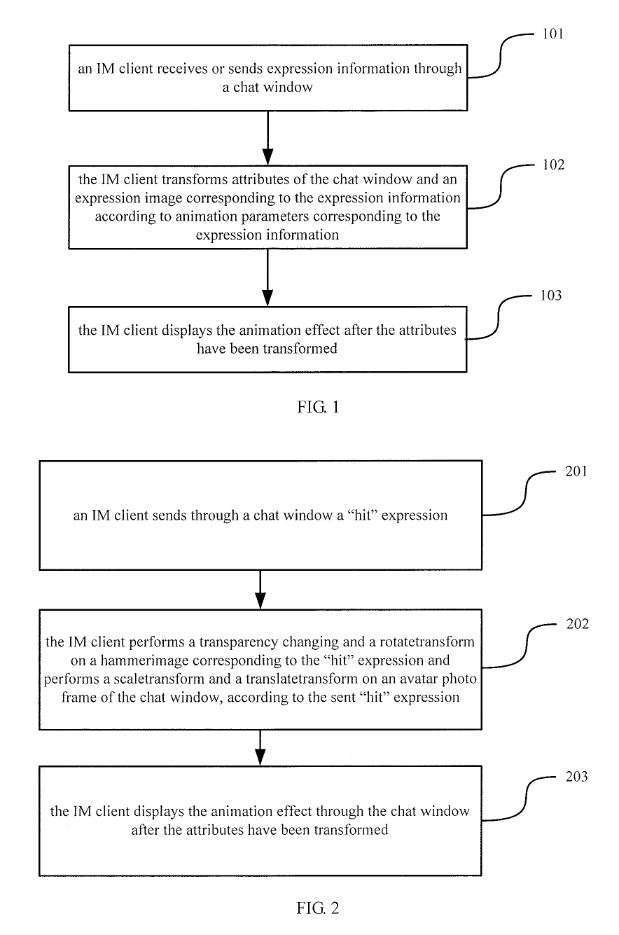

Referring to FIG. 1, a flow chart of a method for displaying expression information of the present invention is shown, the method for displaying expression information can be applied to an instant messaging system and includes following steps:

Step 101: an IM client receives or sends expression information through a chat window.

Specifically, when one user chats with a friend through the IM client, if the user wants to send expression information, the user can click an expression icon in the chat window through which the user chats with the friend, select and click expression information of a menu in a popup expression distribution page card so that corresponding expression information appears in a send content area of the chat window, and click a send button present in an input box to send this expression information to the friend. In addition, during the process that the user chats with the friend through the IM client, the user can also receive expression information sent by the friend through the chat window.

Step 102: the IM client performs an attribute formation on the chat window and an expression image corresponding to the expression information according to animation parameters corresponding to the expression information.

The chat window can include at least one of the following: a frame of the chat window, an avatar photo frame in the chat window and message content in the chat window. The IM client can perform a scaletransform, a translatetransform, a transparency changing and/or a rotatetransform on the expression image corresponding to the expression information and the avatar photo frame in the chat window according to animation parameters corresponding to a sent expression information; and can also perform a scaletransform, a translatetransform, a transparency changing and/or a rotatetransform on the frame of the chat window and the expression image corresponding to the expression information according to the animation parameters corresponding to a received expression information; and can also perform a scaletransform, a translatetransform, a transparency changing and/or a rotatetransform on the expression image corresponding to the expression information, the avatar photo frame in the chat window and the frame of the chat window according to the animation parameters corresponding to the received expression information. The IM client can also set a mask layer on the avatar photo frame in the chat window according to the animation parameters corresponding to the received expression information, and set the expression image corresponding to the expression information on the mask layer, and modify transparency and gradient color of the mask layer. The above expression image can be one or more images; when setting a plurality of expression images, the plurality of expression images can be switchably displayed in the mask layer at the time of modifying the transparency and the gradient color of the mask layer.

Step 103: the IM client displays an animation effect obtained through the attribute transformation.

In the embodiment of the present invention, through performing the attribute transformation on the chat window and the expression image, the animation effect after the attributes have been transformed can be obtained and displayed, and the expression information can be vividly displayed through the chat window, this enriches expression effects and facilitates the user to understand the expression information, and increases the interactivity of the IM client and improves the usability of the IM client.

The method for displaying expression information of the present invention is hereinafter described in details with reference to specific application scenes.

FIG. 2 shows a flow chart of displaying expression information in an application scene of sending a “hit” expression according to the present invention, it specifically includes following steps:

Step 201: an IM client sends through a chat window a “hit” expression such as an expression image of Tencent QQ in which a hammer is hitting an avatar.

Specifically, the user can click an expression icon (such as “smiling face” in the drawings) in the chat window of the IM client, select and click the “hit” expression of a menu in a popup expression distribution page card shown in FIG. 3 so that the “hit” expression appears in a send content area of the chat window, and click a send button present in an input box to send the “hit” expression.

Step 202: the IM client performs a transparency changing and a rotatetransform on a hammerimage corresponding to the “hit” expression and performs a scaletransform and a translatetransform on an avatar photo frame in the chat window, according to animation parameters corresponding to the sent “hit” expression.

Specifically, the scaletransform, the translatetransform, the transparency changing and the rotatetransform each are a linear smoothing transformation. The transparency changing can achieve a gradient from invisibility to full visibility, i.e., fade appearance; can also achieve a gradient from full visibility to invisibility, i.e., fade disappearance. Simultaneously performing the transparency changing and the rotatetransform on the hammerimage can achieve the effect of an appearance of the hammer and hitting the avatar photo frame.

For example, attribute value change tables at the time of performing the transparency changing and the rotatetransform on the hammerimage can be shown in Table 1 and Table 2, respectively.

TABLE 1
Attribute value change table at the time of performing
the transparency changing on the hammerimage

| | transparency (0 represents |
|---|---|
| | completely transparent, i.e., |
| time (unit: | invisibility; 1 represents |
| millisecond) | opaque, i.e., full visibility) |
| 0 | 0 |
| 100 | 0.2 |
| 200 | 0.4 |
| 300 | 0.7 |
| 400 | 0.9 |
| 500 | 1 |
| 700 | 0.6 |
| 800 | 0.3 |
| 900 | 0 |

TABLE 2
Attribute value change table at the time of performing
the rotatetransform on the hammerimage

| time (unit: millisecond) | rotation angle | |
|---|---|---|
| 0 | 0 | degrees |
| 500 | 14 | degrees |
| 600 | −14 | degrees |

In addition, simultaneously performing the scaletransform and the translatetransform on the avatar photo frame can achieve the effect of compression, rebound and vibration of the avatar photo frame after the avatar photo frame has been hit. The scaletransform can achieve the effect of compression and rebound of the avatar photo frame, the translatetransform can achieve the effect of vibration of the avatar photo frame. For example, attribute value change tables at the time of performing a horizontal scaletransform, a vertival scaletransform and the translatetransform on the avatar photo frame can be shown in Table 3, Table 4 and Table 5, respectively.

TABLE 3
Attribute value change table at the time of performing
the horizontal scaletransform on the avatar photo frame

| | Scaling ScaleX in the |
|---|---|
| time (unit: millisecond) | horizontal direction |
| 0 | 1 |
| 700 | 1.02 |
| 800 | 0.9 |
| 900 | 1.2 |
| 1200 | 1 |

TABLE 4
Attribute value change table at the time of performing
the vertical scaletransform on the avatar photo frame

| | Scaling ScaleY in the |
|---|---|
| time (unit: millisecond) | vertical direction |
| 0 | 1 |
| 700 | 0.8 |
| 800 | 1.05 |
| 900 | 0.7 |
| 1000 | 0.95 |
| 1200 | 1 |

TABLE 5
Attribute value change table at the time of performing
the translatetransform on the avatar photo frame

| | displacement in the vertical |
|---|---|
| time (unit: millisecond) | direction (unit: pixel) |
| 0 | 0 |
| 700 | 5 |
| 800 | −4 |
| 900 | 8 |
| 1000 | −1 |
| 1100 | −3 |
| 1200 | 0 |
| 1300 | −2 |
| 1400 | 0 |

Step 203: the IM client displays the animation effect obtained through the attribute transformation by the chat window.

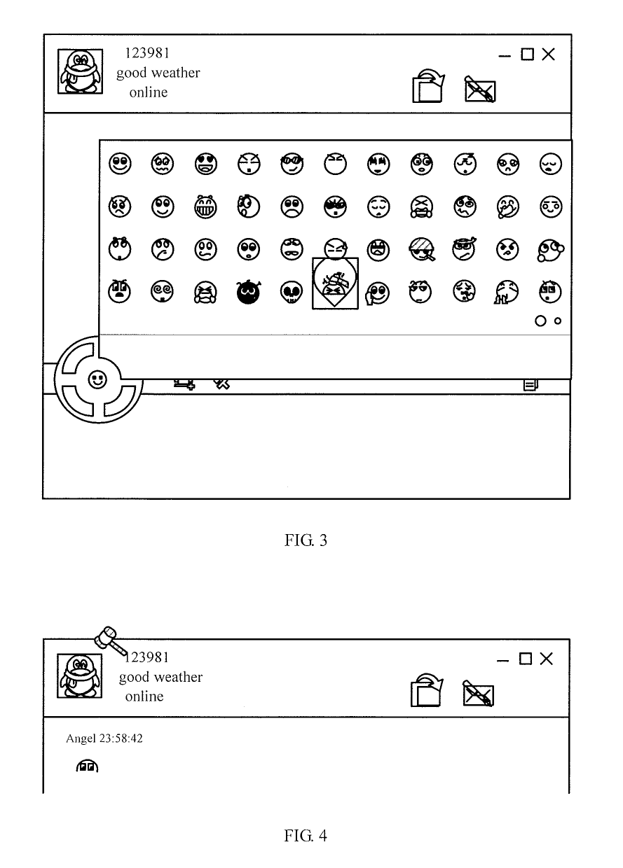

Specifically, after the user sends the “hit” expression through the chat window in the IM client, the chat window can display the following animation effects: a hammer appears above a friend avatar at the upper left corner, and the hammer performs hitting action from top to bottom on the friend avatar to display the effect of the “hitting” expression, as shown in FIG. 4.

In the specific implementation process, the eXtensible Application Markup Language (XAML) based on the Windows Presentation Foundation (WPF) technology can be used to achieve the attribute transformation of the chat window and the expression image.

When performing the transparency changing on the expression image, the XAML can be used to create an animation object and a key frame set corresponding to the transparency changing, the expression image can be set as a target object of the animation, and the animation is used to modify the opacity attribute of the expression image and specify opacity value at each key time point; when performing the rotatetransform on the expression image, a key frame set corresponding to the rotatetransform can be created, the expression image can be set as a target object of the animation, and the animation is used to modify RotateTransform.Angle attribute of the expression image and specify angle value at each key time point.

When the IM client displays the animation effects through the chat window, ((Storyboard)(Resources[“hammerAnimationStoryboard”])).Begin( ) can be called from corresponding implementation procedures to play the corresponding animation effects.

Further, when performing the scaletransform and the translatetransform on the avatar photo frame, the XAML can be used to create the animation object and a key frame set corresponding to the scaling in the horizontal direction, the scaling in the vertical direction and the displacement in the vertical direction, the avatar photo frame can be set as a target object of the animation; and the animation is used to modify the scaling in the horizontal direction, the scaling in the vertical direction and the displacement in the vertical direction of the avatar photo frame and specify the scaling in the horizontal direction, the scaling in the vertical direction and the displacement in the vertical direction at each key time point, respectively.

When the IM client displays the animation effects through the chat window, ((Storyboard)(Resources[“photoFrameAnimationStoryboard”])).Begin( ) can be called from corresponding implementation procedures to play the corresponding animation effects.

In the present invention, through performing the attribute transformation on the chat window and the expression image, the animation effect after the attributes have been transformed can be obtained and displayed, and the expression information can be vividly displayed through the chat window, this enriches the expression effects and facilitates the user to understand the expression information, and increases the interactivity of the IM client and improves the usability of the IM client.

FIG. 5 shows a flow chart of displaying expression information in an application scene of receiving a “hit” expression according to the present invention, and it specifically includes following steps:

Step 501: an IM client receives a “hit” expression through a chat window.

Specifically, when the user chats with a friend through the chat window of the IM client, the friend can also select a “hit” expression in an expression distribution page card to send it to the user, and the user can receive the “hit” expression sent by the friend through the chat window.

Step 502: the IM client performs a transparency changing and a rotatetransform on a bigHammerImage corresponding to the “hit” expression and performs a scaletransform and a translatetransform on the frame of the chat window and the message content in the chat window, according to animation parameters corresponding to the received “hit” expression.

Simultaneously performing the scaletransform and the translatetransform on the frame of the chat window can achieve the animation effect of compression, rebound and vibration of the chat window after the chat window has been hit; simultaneously performing the transparency changing and the rotatetransform on the bigHammerImage can achieve the effect of the big hammer' appearance and hitting. In addition, in the deformation process of the chat window, real-time rendering is performed on the message content in the chat window.

Step 503: the IM client displays the animation effect obtained through the attribute transformation by the chat window.

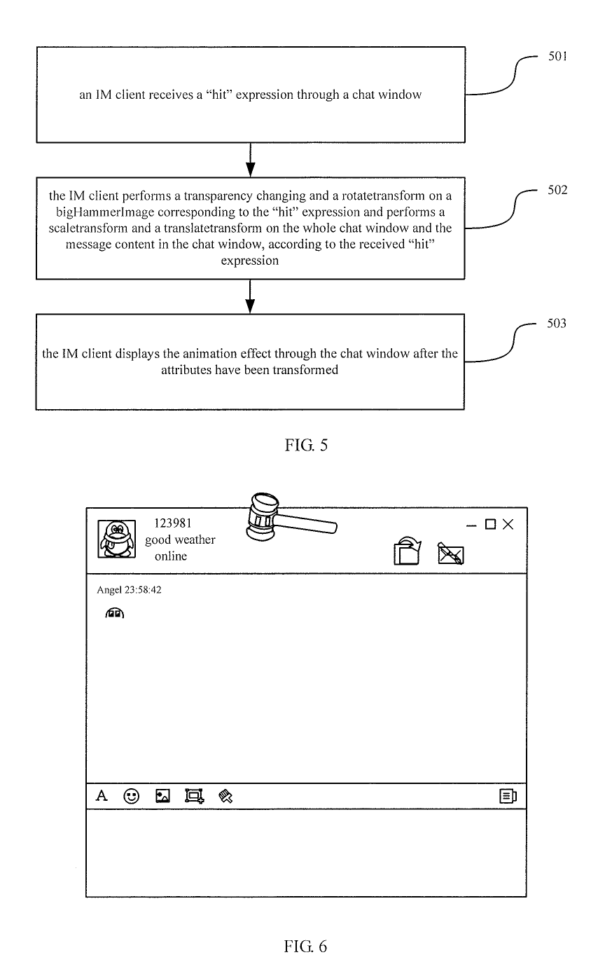

Specifically, after the user receives the “hit” expression through the chat window in the IM client, the chat window can display the following animation effects: a “hammer” pattern appears at the top of the chat window, and the “hammer” hits the window from top to bottom at the top of the window; after the window is hit, the entire window is first compressed at top and bottom to cause its size flat so that the left and right of the window is elongated, then the top and bottom of the window vibrate forth and back a few times to restore to their original at the time that the left and right rebound to the original size, as shown in FIG. 6.

In the present invention, through performing the attribute transformation on the chat window and the expression image, the animation effect after the attributes have been transformed can be obtained and displayed, and the expression information can be vividly displayed through the chat window, this enriches the expression effects and facilitates the user to understand the expression information, and increases the interactivity of the IM client and improves the usability of the IM client.

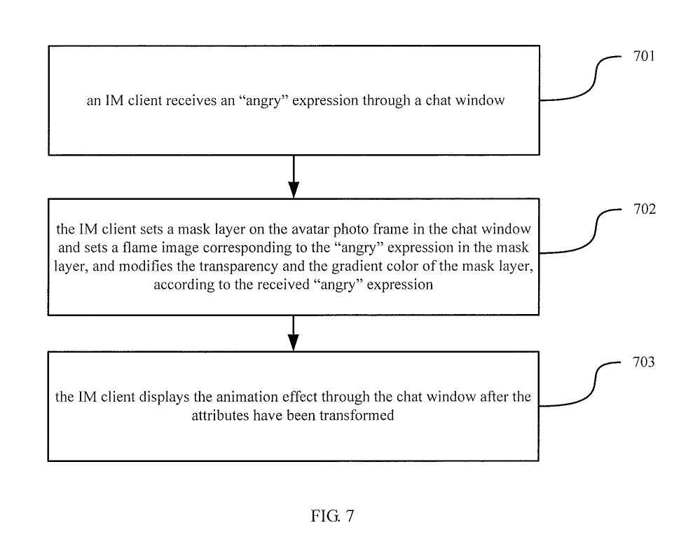

FIG. 7 shows a flow chart of displaying expression information in an application scene of receiving an “angry” expression according to the present invention, it specifically includes

Step 701: an IM client receives an “angry” expression through a chat window.

Specifically, when the user chats with a friend through the chat window of the IM client, the friend can also select an “angry” expression in an expression distribution page card to send it to the user, and the user can receive the “angry” expression sent by the friend through the chat window.

Step 702: the IM client sets a mask layer on the avatar photo frame in the chat window and sets a flame image corresponding to the “angry” expression in the mask layer, and modifies transparency and gradient color of the mask layer, according to animation parameters corresponding to the received “angry” expression.

Specifically, the transparency, the gradient color and other attributes of the mask layer can be modified at different times, meanwhile, different flame images (such as 15 flame images which indicate different flames) can be switchably displayed in turn in the mask layer, to achieve the animation effects in which fire burns and the avatar photo frame and the avatar image are burning red by fire.

Step 703: the IM client displays the animation effect obtained through attribute transformation by the chat window.

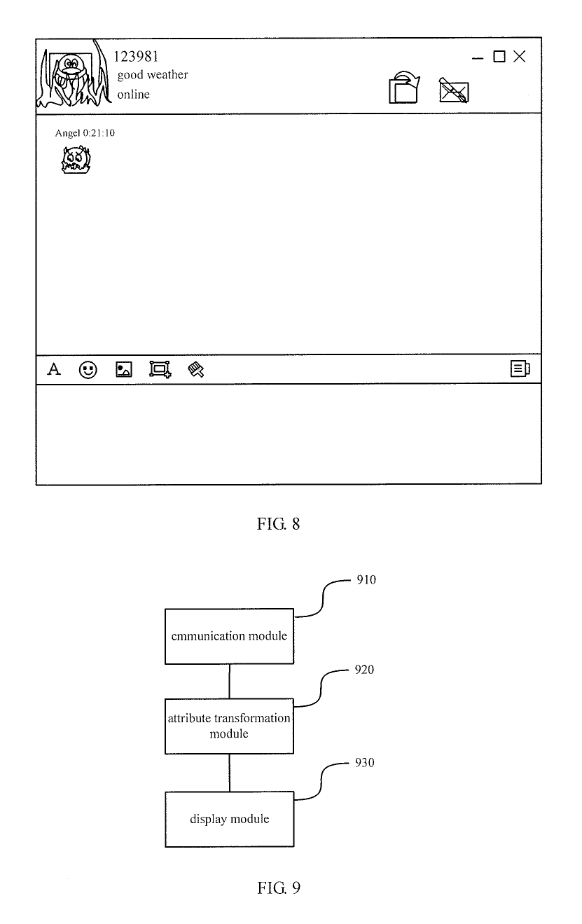

Specifically, after the user receives the “angry” expression through the chat window in the IM client, the chat window can display the following animation effects: a bottom-up flame appears above an upper left friend avatar, and the avatar is burning by the flame until the avatar disappears, after this, the avatar restores the original style; in this expression effect, the burning range of the flame goes beyond an outside frame and a top part of the upper left friend avatar, as shown in FIG. 8.

In this application scene, when the attribute transformations are performed, the XAML can be used to create an animation object and a key frame set corresponding to visibility changing of the plurality of expression images, the expression images can be set as the target object of the animation, and the animation is used to modify the visibility attributes of the expression images and specify whether each expression image is visible at each key time point.

When the IM client displays the animation effects through the chat window, ((Storyboard)(Resources[“fireAnimationStoryboard”])).Begin( ) can be called from corresponding implementation procedures to play the corresponding animation effects.

In the present invention, through performing the attribute transformation on the chat window and the expression image, the animation effect after the attributes have been transformed can be obtained and displayed, and the expression information can be vividly displayed through the chat window, this enriches the expression effects and facilitates the user to understand the expression information, and increases the interactivity of the IM client and improves the usability of the IM client.

The present invention provides the method of displaying expression information and a plurality of application scenes in the above embodiments; accordingly, the present invention also provides an apparatus using the above method for displaying expression information.

FIG. 9 shows a schematic diagram of an apparatus for displaying expression information of the present invention, the apparatus for displaying expression information can be applied to an IM system and includes:

a communication module 910 configured to receive or send expression information through a chat window.

an attribute transformation module 920 configured to perform an attribute transformation on the chat window and an expression image corresponding to the expression information according to animation parameters corresponding to the expression information received or sent by the communication module 910.

Specifically, the above attribute transformation module 920 can perform attribute transformations on the frame of the chat window and the message content in the chat window according to the animation parameters corresponding to the expression information; and can also perform a scaletransform, a translatetransform, a transparency changing and a rotatetransform on the expression image corresponding to the expression information and the avatar photo frame in the chat window according to the animation parameters corresponding to the expression information sent by the communication module 910; and can also perform a scaletransform, a translatetransform, a transparency changing and a rotatetransform on the expression image corresponding to the expression information and the frame of the chat window according to the animation parameters corresponding to the expression information received by the communication module 910; can also set a mask layer on the avatar photo frame in the chat window according to the animation parameters corresponding to the expression information received by the communication module 910, and set the expression image corresponding to the expression information on the mask layer, and modify the transparency and the gradient color of the mask layer. The above expression image can be one or more images; when setting a plurality of expression images, the attribute transformation module 920 can switchably display the plurality of expression images in the mask layer at the time of modifying the transparency and the gradient color of the mask layer.

a display module 930 configured to display the animation effect obtained by the attribute transformation module 920.

In the present invention, through performing the attribute transformation on the chat window and the expression image, the animation effect after the attributes have been transformed can be obtained and displayed, and the expression information can be vividly displayed through the chat window, this enriches the expression effects and facilitates the user to understand the expression information, and increases the interactivity of the IM client and improves the usability of the IM client.

One embodiment of the present invention also provides a client device, which includes the above apparatus for displaying expression information. Based on the above-description of the examples, those skilled in the art would clearly understand that the examples may be implemented by software plus a necessary common hardware platform, of course, they may also be implemented by hardware. In many cases, the former is a preferred manner. Based on such understanding, the essential part of the technical solution of the present invention or the part contributed to the prior art can be in the form of a software product, and the computer software product is stored in a storage medium and includes several codes to make a computer device (such as a handset, a personal computer, a server or a network device) perform the method in embodiments of the present invention.

One skilled in the art may understand that the modules in the apparatus of the embodiments disclosed herein may be distributed in the apparatus of the embodiments according to the descriptions of the embodiments, and may also be varied to be located in one or more apparatuses different from those of the embodiments. The modules of the above embodiments may be integrated into one module or may be further divided into multiple sub-modules.

Sequence number in above embodiments of the present invention is only used for descriptions, which doesn't demonstrate good or better embodiment.

The foregoing are only preferred embodiments of the present invention, and are not used to limit the present invention. Any modification, equivalent replacement, or improvement made without departing from the spirit and principle of the present invention should fall within the scope of the present invention.

1. A method for displaying expression information which is applied to an instant messaging system, the method comprising following steps:
receiving or sending through a chat window, by a client, an expression information;
performing, by the client, an attribute transformation on the chat window and an expression image corresponding to the expression information according to animation parameters corresponding to the expression information, and displaying, by the client, an animation effect obtained through the attribute transformation.

2. The method of claim 1, wherein the chat window includes at least one of a frame of the chat window, an avatar photo frame in the chat window and message content in the chat window.

3. The method of claim 2, wherein the performing an attribute transformation on the chat window and an expression image corresponding to the expression information according to animation parameters corresponding to the expression information comprises:
performing at least one of operations including scaletransform, translatetransform, transparency changing and rotatetransform on an expression image corresponding to the sent expression information and the avatar photo frame in the chat window, according to animation parameters corresponding to a sent expression information.

4. The method of claim 2, wherein the performing an attribute transformation on the chat window and an expression image corresponding to the expression information according to animation parameters corresponding to the expression information comprises:
performing at least one of operations including scaletransform, translatetransform, transparency changing and rotatetransform on an expression image corresponding to the received expression information and the frame of the chat window, according to animation parameters corresponding to a sent expression information.

5. The method of claim 2, wherein the performing an attribute transformation on the chat window and an expression image corresponding to the expression information according to animation parameters corresponding to the expression information comprises:
setting a mask layer on the avatar photo frame in the chat window, setting an expression image corresponding to the received expression information in the mask layer, and modifying transparency and gradient color of the mask layer, according to animation parameters corresponding to a received expression information.

6. The method of claim 2, wherein the performing an attribute transformation on the chat window and an expression image corresponding to the expression information according to animation parameters corresponding to the expression information comprises:
performing at least one of operations including scaletransform, translatetransform, transparency changing and rotatetransform on an expression image corresponding to the sent expression information, the avatar photo frame in the chat window and the frame in the chat window, according to animation parameters corresponding to a sent expression information.

7. An apparatus for displaying expression information which is applied to an instant messaging system, the apparatus comprising:
a communication module configured to receive or send expression information through a chat window;
an attribute transformation module configured to perform an attribute transformation on the chat window and an expression image corresponding to the expression information according to animation parameters corresponding to the expression information received or sent by the communication module;
a display module configured to display animation effect obtained by the attribute transformation module.

8. The apparatus of claim 7, wherein
the attribute transformation module is configured to, according to the animation parameters corresponding to the expression information, perform an attribute transformation on at least one of a frame of the chat window, an avatar photo frame in the chat window and message content in the chat window.

9. The apparatus of claim 7, wherein
the attribute transformation module is configured to, according to animation parameters corresponding to an expression information sent by the communication module, perform at least one of operations including scaletransform, translatetransform, transparency changing and rotatetransform on an expression image corresponding to the expression information sent by the communication module and an avatar photo frame in the chat window.

10. The apparatus of claim 7, wherein
the attribute transformation module is configured to, according to animation parameters corresponding to an expression information received by the communication module, perform at least one of operations including scaletransform, translatetransform, transparency changing and rotatetransform on an expression image corresponding to the expression information received by the communication module and a frame of the chat window.

11. The apparatus of claim 7, wherein
the attribute transformation module is configured to, according to animation parameters corresponding to an expression information received by the communication module, perform at least one of operations including scaletransform, translatetransform, transparency changing and rotatetransform on an expression image corresponding to the expression information received by the communication module, an avatar photo frame in the chat window and a frame of the chat window.

12. The apparatus of claim 7, wherein
the attribute transformation module is configured to, according to animation parameters corresponding to an expression information received by the communication module, set a mask layer on an avatar photo frame in the chat window, set an expression image corresponding to the expression information received by the communication module in the mask layer, and modify transparency and gradient color of the mask layer.

13. A client device comprising a computer storage media for storing computer-executable instructions, the computer-executable instructions being for displaying expression information which is applied to an instant messaging system, the method comprising:
receiving or sending through a chat window, by a client, an expression information;
performing, by the client, an attribute transformation on the chat window and an expression image corresponding to the expression information according to animation parameters corresponding to the expression information, and displaying, by the client, an animation effect obtained through the attribute transformation.
